(19) United States
(12) Patent Application Publication
(10) Pub. No.: US 2008/0128465 A1
(43) Pub. Date: Jun. 5, 2008

(54) Recessed dispenser for plastic bags

(76) Inventor: Harry B. Wilfong, Hartsville, SC (US)

Correspondence Address: IP GROUP OF DLA PIPER US LLP, ONE LIBERTY PLACE, 1650 MARKET ST, SUITE 4900, PHILADELPHIA, PA, 19103, US

(21) Appl. No.: 11/607,665

(22) Filed: Dec. 1, 2006

(51) Int. Cl. B65H 35/00; B26F 3/02

(52) U.S. Cl. 225/106

(57) ABSTRACT

A packet of plastic bags, formed in a stack, is retained within a housing that defines a dispenser. The packet is supported at the upper edge thereof, with the stack hanging within the interior of the housing. The bag packet is positioned within a channel defined in the housing. On opposite sides of the channel is provided an engagement bar for contacting the edges of the bag packet. The engagement bar may be resilient and in the form of a brush. The contact of the engagement bar serving to orderly retain the bags in the stack during removal of an individual bag from the housing.

### FIELD OF THE INVENTION

The present invention relates to an apparatus for dispensing plastic bags, such as the type commonly provided in the produce section of a grocery store.

### BACKGROUND OF THE INVENTION

Plastic bags have been used as replacements for paper bags for decades. A particular application for plastic bags is in the grocery and retail products industry. Much of the success of plastic bags is due to the inherent moisture-resistant properties and strength of plastic. Plastic grocery and retail bags often include integrally connected front and rear walls and gusseted side walls. The bag is open at the top to define a mouth for placing items into the bag. Some bags are “T-shirt” style, having spaced integral handles laterally extending from opposite sides of the mouth. These handles make it easy to carry the bag when filled with goods. Other plastic bags are handleless, similar to paper bags, or include alternate handle structures extending from the upper edges of the bag. Grocery and retail bags are typically manufactured from LDPE and/or HDPE and have a wall thickness that ranges from 0.50 to 0.35 mil.

One variation of plastic bags is known as a “star-seal” style bag. The star-seal design typically includes multiple layers which are longitudinally folded over one another and sealed at the bottom. When the bag is open, the bottom of the bag (viewed on the inside) resembles a star. Star-seal bags have been used as trash can liners and also find application as produce bags. Star-seal bags may be provided in roll form, as described in, e.g., U.S. Pat. No. 6,230,953, and in packet form, as described in, e.g., U.S. Pat. No. 5,941,393 and U.S. Pat. No. 6,446,811. The disclosures of these patents are herein incorporated by reference.

Star-seal bags and other bag configurations provided in packets, which can include bags generally referred to as header-style bags as well as T-shirt type bags, are typically dispensed from a rack having one or more hooks or arms from which the packet hangs. A severable support is provided at the top of the bag, adjacent the mouth opening, which fits over the hook. The amount of vertical space occupied by the hanging bags is defined by the length of the bags themselves. One form of dispensing apparatus for star-sealed bags is shown in US 2006/0021956. This patent publication is also herein incorporated by reference.

As with any dispensing apparatus, it is often desirable to position the dispenser within the confines of existing fixtures within a retail, grocery or similar store.

With many plastic bag products, there is often an issue of determining the open end of the bag, once the bag has been removed from a stack or from a roll. Also, there is often static electricity created by removal of a bag that causes bags to stick together. The static attraction makes it difficult to find the open end of the bag and causes portions of the bag being removed from the packet (or the like) to take with it the next bag in the stack.

### BRIEF SUMMARY OF THE INVENTION

The present invention relates to a dispenser for a packet of plastic bags. The plastic bags are of the type that have an open mouth at one end and a severable support positioned adjacent the mouth opening. The dispenser comprises a housing defining an interior volume that is configured to receive the packet of bags. An opening is provided on the housing, providing access to the interior of the housing from the outside environment. A bag mount is provided within the housing and engages the severable support of the bags to secure the packet within the housing. The bag packet is retained within a dispensing channel having a width that is greater than the width of the packet. An engagement bar is positioned on the sides of the bag packet and contacts the opposing edges of the packet within the channel. The engagement bar is preferably a resilient member, such as a brush or flap. The contact of the bar on the side edges of the bag packet preferably disrupts the alignment of the bags in the packet as they hang in the channel and provides a resistance to removal of the bags. The contact resistance of the engagement bar is such that removal of the top most bag in the packet is not inclined to pull other bags from the stack.

### BRIEF DESCRIPTION OF THE DRAWINGS

For the purpose of illustrating the invention, there are shown in the drawings forms of the invention which are presently preferred; it being understood, however, that the invention is not limited to the precise arrangements and instrumentalities shown.

FIG. 1 shows a dispenser of the type contemplated by the present invention as mounted on a retaining wall of a store fixture or the like, shown in phantom.

FIG. 2 shows the dispenser of FIG. 1 having bag packets retained therein.

FIG. 3 is a cross sectional view of the dispenser of FIG. 1 showing the removal of the outer bag from the packet.

FIG. 4 shows a further embodiment of a dispenser as contemplated by the present invention.

### DETAILED DESCRIPTION OF THE DRAWINGS

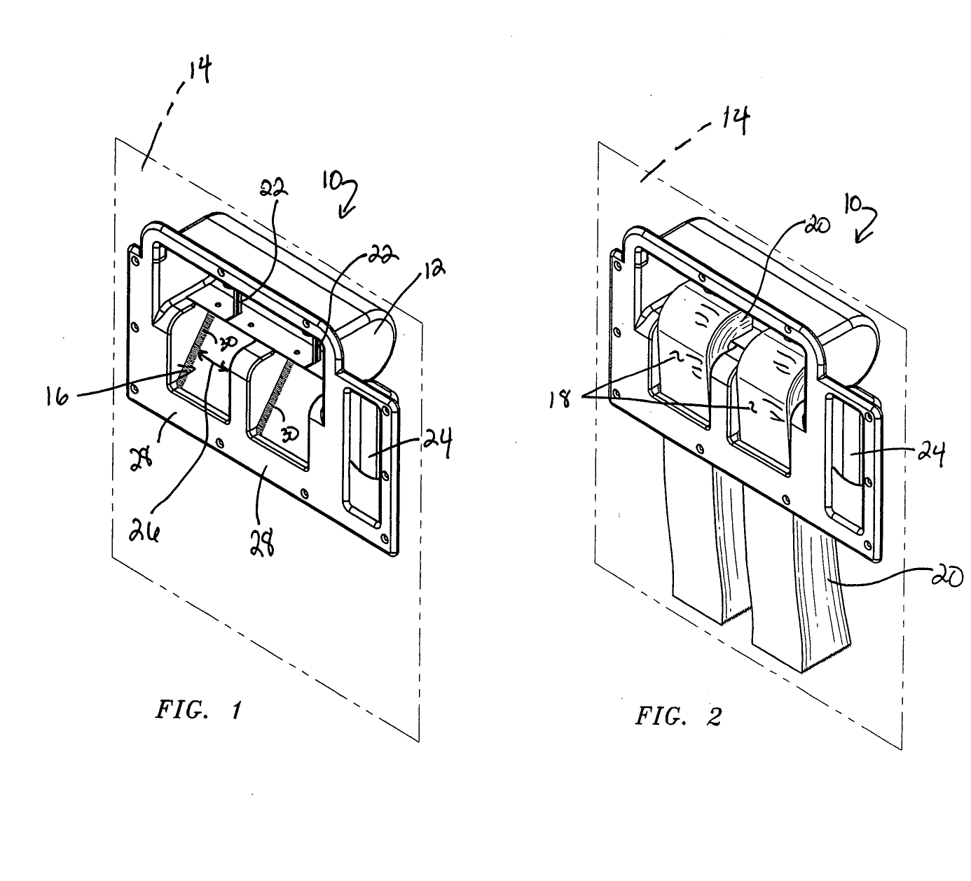

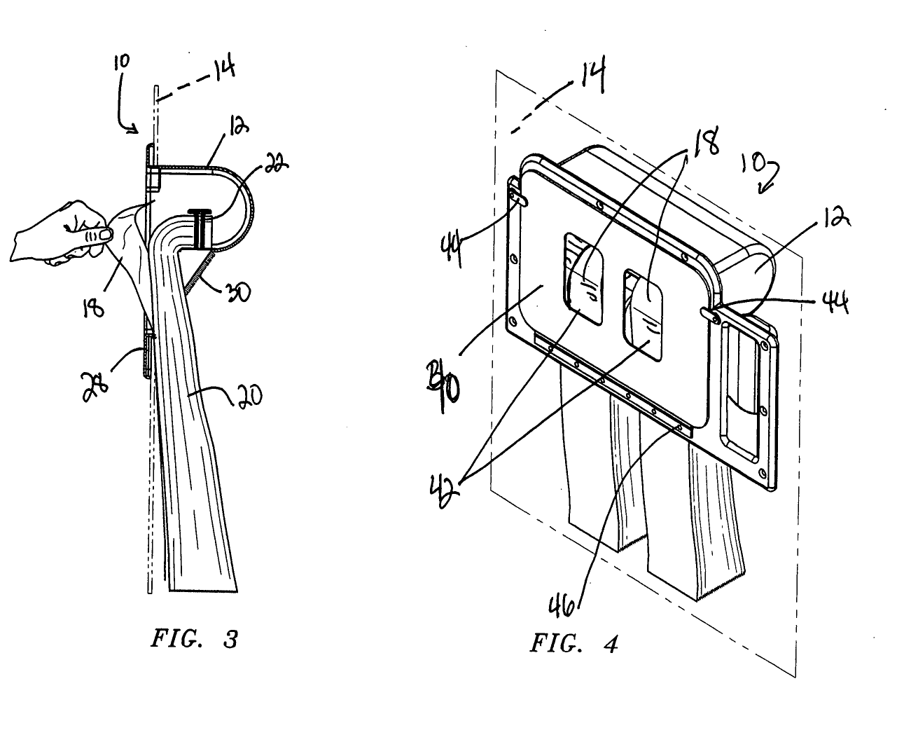

Referring to the drawings, wherein like numerals identify like elements, there is shown a dispenser for retaining and dispensing plastic bags. The dispenser is generally referred to by the numeral 10. The dispenser 10 as shown in FIGS. 1, 2 and 3 generally comprises a housing 12, which is mounted on a wall 14 (shown in phantom). An opening 16 into the housing 12 is provided for access to a plastic bag 18 (FIGS. 2 and 3), which is the outermost bag in a formed packet or stack 20. A mount 22 is provided within the housing 12 for supporting the bag packet 20 at its upper end, with the remaining portion of the packet 20 hanging downwardly below the opening 16 and behind the wall 14. A pocket 24 is provided on the housing 12 adjacent to the opening 16 to retain a plurality of closure members (not shown), such as twist ties or the like, for closing a bag once it is removed from the dispenser and filled with goods (also not shown).

Each bag packet 20 is positioned within a defined channel 26 formed inside the housing 12. The channel 26 is preferably wider than the width of the bag packet 20 retained on the mount 22. The mount 22 is positioned at the top of the channel 26 and is in the form of a hook or the like.

The bag formation, as contemplated for normal use with the embodiments illustrated, includes an aperture at the top. When placed in a packet, the apertures are aligned. The aperture is positioned adjacent the mouth of the bag and provides a severable means for supporting the bags and the bag packet within the dispenser. Various forms of bags of the type contemplated for use with the present invention are shown in U.S. Pat. No. 5,941,393 and U.S. Pat. No. 6,446,811. Various mounting means for supporting the bags by their severable support are shown in US 2006/0021956. Other bag formations and support means are contemplated and may be used with the present invention.

The mount 22 is positioned along a bar secured to the housing 12 at the top of the channel 26. The bag packet 20, as particularly illustrated in FIGS. 2 and 3, is supported at its upper end, dangles downwardly through the channel 26 and extends into the interior of the fixture 14. The packet 20 is positioned behind a retaining bar 28, which forms the lower lip of the housing 12, at the bottom end of the channel 26.

On opposite sides of the channel 26 are engagement bars 30, which are directed inwardly toward the middle of the channel 26. As illustrated, the bars 30 are angled rearwardly from the lip 28 of the housing 12 and extend upwardly across the side edges of the bags as they hang from the mount 22. The bars 30 may be in the form of a bristled brush, which resiliently contacts the bag edges at a number of positions. As the bags are individually removed from within the housing 12, the edges of the bars 30 “tickle” the side edges of the bag packet. It is contemplated that other forms of engagement bars may be utilized. For example, the bar may be a resilient flap that contacts the bag packet linearly or in segments. A rigid bar may also be used, preferably having a rounded or curved edge, that contacts the side of the bag packet and slightly disrupts the alignment of the bags as they hang in the channel.

In the embodiment illustrated in FIG. 4, the dispenser 10 includes a housing 12 similar to the housing in FIGS. 1-3. A cover 40 is provided over the front of the housing 12, covering the opening 16. Two dispensing slots 42 are provided in the cover 40, corresponding to the number of bag packets. Each dispensing slot 42 is positioned adjacent the top bag 18 in the packet 20. The cover 40 is substantially flush with the fixture wall 14 (shown in phantom). The cover 40 closes a portion of the housing for esthetic purposes or cleanliness. The cover may be opened by rotation of tabs 44, which are moved out of engagement with the cover 40, and by pivoting the cover about the hinge 46 positioned at the bottom edge thereof.

In a grocery environment, display fixtures typically include a platform with a series of steps or shelves on which are stacked goods, such as produce, cans or other items. Plastic bags are often provided adjacent the fixture so that a consumer may take a bag, open it, fill it with goods, seal it and place it into the shopping cart. Providing a bag packet adjacent the store fixture is discussed in US 2006/0021956. Considerable space is provided below the support surface of a typical fixture. The present invention may be positioned under the support surface of the fixture, providing easy access to the bags retained within the dispenser. In this position, the bag packet is (likely) positioned relatively below the goods and thus the removal of the bag requires an upward pull from the dispenser opening.

In operation of the present dispenser 10, the housing 12 is positioned behind the fixture wall 14, with the opening 16 (or dispensing slots 42) facing outwardly toward the consumer. The outer most plastic bag 18 is visible through the opening (or dispensing slot) with the bag packet 20 positioned thereunder. The bag packet 20 is secured by the mount 22 and extends downwardly into the channel 26 defined within the housing 12. The front bag 18 rests against the lip 28 at the lower end of the housing 12, such that at least a portion of the weight of the bag packet 20 presses the bag against the lip.

A consumer reaches into the opening 16, pinches a portion of the upper edge of the bag 18 and pulls the bag from the packet 20, back through the opening 16. As illustrated in FIG. 3, the outermost bag 18 separates from the mount 22 by tearing through the severable support aperture. As the upper end of the bag 18 is removed through the opening 16, the bottom end of the bag begins to slide upwardly between the lip 28 and the remaining bags in the packet 20. Since the bags are made of flexible plastic, static electricity may be created. If the bags are allowed to hang freely, it is possible for the inside surface of the top bag to cause a secondary bag to move with the top bag. As this repeats, it is possible for the bag packet to become untidy, as multiple bags are removed from the packet at any given time. In order to help resolve this issue, the resilient bar 30 contacts opposite sides of the bag packet 20.

The engagement bar 30 preferably extends across the entire packet. In the brush embodiment illustrated, the bristles of the bar contact the side edges of the bags. This contact disrupts the bags in the packet, helps relieve some of the cling created between the bags and assists in maintaining the bags in the downwardly suspended position. It is contemplated that the bar and bristles (or the like) will be positioned slightly inward of the edges of the bags, and preferably on both sides of the channel. As illustrated, the engagement bar is provided at an angle, which may further enhance the separation of the bags as the top bag is removed from the packet. It is possible for the bar to be separated from the side edge of the bag packet. The bags may experience some side to side movement during dispensing, which will assist in the bar contacting the bag packet. The resilience of the flap or bristles should be sufficient to contact the bags gently. The removal of the bags preferably bends the bristles or flap so as to not tear or prick the bags.

Although the invention has been described and illustrated with respect to the exemplary embodiments, it should be understood to those skilled in the art that various other changes, omissions and additions may be made therein without parting from the spirit and scope of the present invention.

What is claimed is:

1. A dispenser for retaining and supporting a packet of plastic bags, the packet including a plurality of bags each having a severable retainer at the top end, adjacent to the open end of the bag, the dispenser comprising:
a housing defining an interior channel configured to receive a packet of bags, the housing having an opening connecting the interior of the housing to the outside environment,
a mount to engage and support the bag packet by the severable retainer at the upper end of the packet, the mount positioned above the channel, within the interior of the housing, and the remaining portion of the bag packet hanging within the channel, and
an engagement bar positioned within the channel, adjacent a side edge of the bag packet for resilient contact therewith.

2. The dispenser as claimed in claim 1, wherein the engagement bar is formed by a brush having a plurality of bristles for resilient contact with the side edge of a bag packet in the channel.

3. The dispenser as claimed in claim 1, wherein the engagement bar is positioned on one side of a bag packet within the channel and a second engagement bar is positioned on the opposite side of the channel for contact with the opposite side edge of the bag packet.

4. A dispenser as claimed in claim 3, wherein the two engagement bars are positioned parallel one another on opposite sides of the channel, the two bars being separated by a distance which is slightly less than the nominal width of a bag packet.

5. A dispenser as claimed in claim 1, wherein the engagement bar is angled upwardly and rearwardly within the housing.

6. A dispenser as claimed in claim 1, wherein the engagement bar is resilient, providing a flexible contact with the edge of the bag packet.

7. A dispenser as claimed in claim 1, wherein the housing comprises a lower retaining lip that contacts the front surface of a bag packet suspended within the channel.

8. A dispenser as claimed in claim 7, wherein the engagement bar angles upwardly and rearwardly from the front lip.

9. A dispenser as claimed in claim 1 further comprising a cover removably attached to the housing and covering the opening, the cover having a dispensing slot for providing access from the exterior of the housing to the bag packet retained within the housing.

10. A dispenser as claimed in claim 1 further comprising a second defined channel to receive a second packet of bags and a second engagement bar positioned within the second channel for resilient contact with a bag packet positioned therein.

11. A dispenser for retaining and supporting a plurality of plastic bags assembled in a packet, the dispenser comprising:
a housing having an interior channel for receiving a bag packet,
mounting means for supporting a bag packet in the housing, and
resilient means for resiliently contacting the side edges of a bag packet within the channel,
an opening is provided in the housing, providing access to bags mounted in the housing from the exterior of the housing, and the resilient means contacting the side edges of the bag packet during removal of a bag from a packet and the housing.

12. A dispenser as claimed in claim 11, wherein the resilient means is in the form of an elongated brush having flexible bristles that resiliently contact a bag packet positioned within the channel.
